(19) United States
(12) Patent Application Publication
(10) Pub. No.: US 2005/0178056 A1
(43) Pub. Date: Aug. 18, 2005

(54) Landscaping fabrics and methods of making and using the same

(76) Inventor: Jack Lee Morrone, Macon, GA (US)

Correspondence Address: Withers & Keys, LLC, P.O. Box 2049, McDonough, GA, 30253, US

(21) Appl. No.: 10/779,122

(22) Filed: Feb. 13, 2004

(51) Int. Cl. A01G 13/02

(52) U.S. Cl. 47/9

(57) ABSTRACT

The present invention is directed to landscaping fabrics, and methods of making and using landscaping fabrics.

### FIELD OF THE INVENTION

The present invention relates to landscaping fabrics, and methods of making and using such landscaping fabrics.

### BACKGROUND OF THE INVENTION

There is a need in the art for landscaping fabrics having one or more of the following properties:
(1) the ability to provide one or more plant nutrients to a plant growing medium;
(2) the ability to prevent the undesirable growth of weeds in a plant growing medium;
(3) the ability to prevent the undesirable growth of fungus in a plant growing medium; and
(4) the ability to control fluid flow, such as water or rain water, into a plant growing medium.

### SUMMARY OF THE INVENTION

The present invention is directed to landscaping fabrics. The landscaping fabrics comprise one or more layers, wherein each layer provides desired properties to the landscaping fabric. The landscaping fabrics of the present invention provide one or more of the following features: (1) the ability to provide one or more plant nutrients to a plant growing medium; (2) the ability to prevent the undesirable growth of weeds in a plant growing medium; (3) the ability to prevent the undesirable growth of fungus in a plant growing medium; and (4) the ability to control fluid flow, such as water or rain water, into a plant growing medium.

In one exemplary embodiment of the present invention, the landscaping fabric comprises at least one fabric comprising a plurality of fibers and interstitial voids throughout the plurality of fibers, wherein the at least one fabric has an upper surface and a lower surface; and a nitrogen-containing, fertilizer within the at least one fabric such that the fertilizer coats at least a portion of the plurality of fibers and occupies at least a portion of the interstitial voids within the at least one fabric. The landscaping fabric may further include additional components within the fabric layer such as water saving crystals, a fungicide, a pre-emergent weed killer, a post-emergent weed killer, or mixtures thereof. Further, the landscaping fabric may include one or more additional layers on the upper and/or lower outer surfaces of the fabric layer. Suitable additional layers include, but are not limited to, a protective layer, a reinforcing layer, or a combination thereof.

In a further exemplary embodiment of the present invention, the landscaping fabric comprises (i) at least one fabric comprising a plurality of fibers and interstitial voids throughout the plurality of fibers, wherein the at least one fabric has an upper surface and a lower surface; (ii) a nitrogen-containing, fertilizer within the at least one fabric such that the fertilizer coats at least a portion of the plurality of fibers and occupies at least a portion of the interstitial voids within the at least one fabric; and (iii) an outermost protective layer at least partially covering (i) the upper surface of the at least one fabric, (ii) the lower surface of the at least one fabric, or (iii) both the upper and lower surfaces of the at least one fabric. The protective layer provides temporary protection to a user from physical exposure to chemicals within the fabric layer of the landscaping fabric. Desirably, the outermost protective layer comprises a water-soluble coating or a removable release liner.

In an exemplary embodiment of the present invention, the landscaping fabric is substantially free of seeds. In this embodiment, the landscaping fabric may be used to provide nutrients to a plant growing medium, while preventing the growth of undesirable weeds through the landscaping fabric. Openings may be cut in the landscaping fabric as desired to position plants within outer boundaries of the landscaping fabric. In such a landscaping system, controlled growth of desired plants without weeds may be obtained.

The present invention is further directed to methods of making landscaping fabrics. In one exemplary method of making a landscaping fabric, the method comprises spraying a fertilizer-containing liquid onto a fabric layer, and drying the fabric layer to form a dried fabric layer. The exemplary method may further comprise a number of steps including, but not limited to, a step of bonding a reinforcing layer to the fabric layer, a step of providing a protective coating layer onto an outer surface of the fabric layer.

The present invention is even further directed to methods of using landscaping fabrics. Exemplary methods of use include, but are not limited to, the use of a landscaping fabric as a ground cover for a plant growing medium, the use of a landscaping fabric as a roll-up liner for 15 sod farms, the use of a landscaping fabric as a flower flat, the use of a landscaping fabric as a house mat for growing plants indoors, the use of a landscaping fabric as a wildflower growing medium for plant erosion control, the use of a landscaping fabric as growing medium for potted plants, the use of a landscaping fabric as a greenhouse barrier, and the use of a landscaping fabric for customized plant growing and/or farming.

These and other features and advantages of the present invention will become apparent after a review of the following detailed description of the disclosed embodiments and the appended claims.

### BRIEF DESCRIPTION OF THE DRAWINGS

The present invention is further described with reference to the appended figures, wherein:

FIG. 1 depicts an exemplary landscaping fabric of the present invention;

FIG. 2 depicts an exemplary landscaping fabric of the present invention comprising a protective layer and a reinforcing layer;

FIG. 3 depicts an exemplary landscaping fabric in roll form; and

FIG. 4 depicts an exemplary process for making a landscaping fabric of the present invention.

### DETAILED DESCRIPTION OF THE INVENTION

The present invention is directed to landscaping fabrics. The landscaping fabrics of the present invention may be used as a plant nutrient delivery system for providing one or more plant nutrients to a plant growing medium. The landscaping fabrics of the present invention may be used to prevent the undesirable growth of weeds, fungus, or any other undesirable living organism in a plant growing medium. The landscaping fabrics of the present invention may also be used to control fluid flow, such as water or rain water, into a plant growing medium.

The present invention is also directed to methods of making landscaping fabrics and various specific uses for the landscaping fabrics. The landscaping fabrics of the present invention may be manufactured using known fabric-forming processes, coating processes, and drying processes.

The landscaping fabrics of the present invention comprise a variety of materials, which provide one or more of the above-mentioned desired properties. A description of suitable materials for forming the landscaping fabrics of the present invention is given below.

I. Landscaping Fabric Components

The landscaping fabrics of the present invention may comprise one or more layers of material, wherein each layer contributes at least one desired property to the resulting landscaping fabrics. Suitable layers and layer components for forming the landscaping fabrics of the present invention are described below.

A. One or More Fabric Layers

The landscaping fabrics of the present invention desirably comprise one or more fabrics layers. Desirably, at least one of the one or more fabrics layers (and possibly all of the one or more fabrics layers) comprises a plurality of fibers and interstitial voids throughout the plurality of fibers, such that the fabric layer is capable of absorbing one or more liquid compositions applied to the fabric layer. Suitable liquid-absorbing fabric layers include, but are not limited to, nonwoven fabrics, woven fabrics, knitted fabrics, or combinations thereof. In one desired embodiment of the present invention, the liquid-absorbing fabric layer comprises a nonwoven fabric. Suitable nonwoven fabrics include, but are not limited to, meltblown fabrics, spunbonded fabrics, needle-punched fabrics, spunlaced fabrics, stitchbonded fabrics, hydroentangled fabrics, or combinations thereof.

1. Liquid-Absorbing Fabric Layers

The liquid-absorbing fabric layer may comprise synthetic fibers, natural fibers, or a combination thereof. Suitable synthetic fibers include, but are not limited to, mono-component fibers formed from one fiber-forming material such as polypropylene, polybutylene, polyethylene terephthalate, polyamide, and polyvinyl alcohol; multi-component fibers formed from two or more fiber-forming materials such as polypropylene, polybutylene, polyethylene terephthalate, polyamide, and polyvinyl alcohol; and mixtures thereof. Suitable natural fibers include, but are not limited to, cotton fibers, viscose fibers, wood pulp fibers, and combinations thereof.

When synthetic fibers are used to form the fabric layer, either alone or in combination with natural fibers, at least a portion of the synthetic fibers may be mono-component synthetic fibers (e.g., fibers formed from a single type of fiber-forming material, such as a polypropylene material), multi-component fibers (e.g., fibers formed from two or more types of fiber-forming material, such as a mixture of polypropylene and polyamide materials), or a combination thereof. Desirably, the synthetic fibers are hydrophilic. The synthetic fibers may be hydrophilic based on the chemistry of the fiber-forming material, the chemistry of additives provided in the fiber-forming material during fiber preparation, the chemistry of additives provided on the fiber surface after fiber preparation, or any combination thereof. Suitable hydrophilic synthetic fibers and methods of making the same are disclosed, for example, in U.S. Pat. Nos. 5,849,000; 6,025,535; and 6,146,757; the subject matter of each of which is hereby incorporated herein in its entirety.

Desirably, each layer of liquid-absorbing fabric (i.e., spunbonded fabric, meltblown fabric layer, needle-punched fabric layer, or any other type of liquid-absorbing fabric layer) has a fabric construction, basis weight, and fabric thickness so as to possess an absorption capacity of up to about 500 grams (g) of fertilizer-containing composition per square meter (m²) of fabric. More desirably, each layer of liquid-absorbing fabric (i.e., spunbonded fabric, meltblown fabric layer, needle-punched fabric layer, or any other type of liquid-absorbing fabric layer) has an absorption capacity of from about 50 to about 250 grams (g) of fertilizer-containing composition per square meter (m²) of fabric. Even more desirably, each layer of liquid-absorbing fabric (i.e., spunbonded fabric, meltblown fabric layer, needle-punched fabric layer, or any other type of liquid-absorbing fabric layer) has an absorption capacity of from about 130 to about 210 grams (g) of fertilizer-containing composition per square meter (m²) of fabric.

In most embodiments, the fibers within a given fabric layer of the one or more fabric layers are uniformly distributed within the given fabric layer. However, there may be some embodiments wherein it is desirable to have a non-uniform distribution of fibers within a given fabric layer of the one or more fabric layers.

A number of particularly suitable liquid-absorbing fabrics for use in the present invention are described below.

a. Spunbonded Fabrics

In one exemplary embodiment of the present invention, the landscaping fabric comprises one or more liquid-absorbing fabric layers, wherein at least one liquid-absorbing fabric layer comprises a spunbonded fabric. The fibers of the spunbonded fabric layer may be made from a variety of materials depending on a number of factors including, but not limited to, processability of the fiber-forming material, desired properties of the individual fabric layer and the resulting landscaping fabric, and manufacturing costs. Suitable fiber-forming materials include, but are not limited to, polypropylene, polybutylene, polyethylene terephthalate, polyamide, and combinations thereof. Desirably, the fibers of the spunbonded fabric layer comprise a hydrophilic material, such as a hydrophilic polypropylene or a hydrophilic polyester.

Desirably, the fibers of the spunbonded fabric layer have an average fiber diameter of less than about 100 microns. More desirably, the fibers have an average fiber diameter of from about 0.5 micron to about 40 microns. Even more desirably, the fibers have an average fiber diameter of from about 10 micron to about 35 microns.

The spunbonded fabric layer may have a basis weight, which varies depending upon the particular end use of the individual fabric layer and the resulting landscaping fabric. Desirably, the spunbonded fabric layer has a basis weight of less than about 500 grams per square meter (gsm). More desirably, the spunbonded fabric layer has a basis weight of from about 25 gsm to about 200 gsm. Even more desirably, the spunbonded fabric layer has a basis weight of from about 50 gsm to about 160 gsm, even more desirably from about 50 gsm to about 80 gsm.

As with the basis weight, the spunbonded fabric may have a thickness, which varies depending upon the particular end use of the individual fabric layer and the resulting landscaping fabric. Desirably, the spunbonded fabric has a thickness of less than about 1000 microns (μm). More desirably, the spunbonded fabric has a thickness of from about 10 μm to about 500 μm. Even more desirably, the spunbonded fabric has a thickness of from about 20 μm to about 100 μm.

Commercially available spunbonded fabrics suitable for use in the present invention include, but are not limited to, spunbonded fabrics commercially available from BBA Simpsonville (Simpsonville, S.C.) under the trade designation CELESTRA®, as well as spunbonded fabrics commercially available from Cerex Advanced Fabrics (Pensacola, Fla.), and other manufacturers.

b. Meltblown Fabrics

In a further exemplary embodiment of the present invention, the landscaping fabric comprises one or more liquid-absorbing fabric layers, wherein at least one liquid-absorbing fabric layer comprises a layer of meltblown fibers. Desirably, the layer of meltblown fibers is a nonwoven fabric. In other words, the layer of meltblown fibers possesses enough structural integrity to form a nonwoven fabric, which may exist as a nonwoven fabric without the need for a supporting substrate. The meltblown fibers may be (1) autogenously bonded to one another, (2) bonded to one another using an external source of heat and/or pressure, or (3) both (1) and (2). As used herein, the term “autogenously bonded” is used to describe fibers, which bond to one another as the fibers come into contact with one another after leaving an extrusion die.

The fibers of the meltblown fabric layer may be made from a variety of materials depending on a number of factors including, but not limited to, processability of the fiber-forming material, desired properties of the individual fabric layer and the resulting landscaping fabric, and manufacturing costs. Suitable fiber-forming materials include, but are not limited to, polypropylene, polybutylene, polyethylene terephthalate, polyamide, and combinations thereof. Desirably, the fibers of the meltblown fabric layer comprise polypropylene, more desirably, hydrophilic polypropylene. Commercially available polypropylenes suitable for use in the present invention include, but are not limited to, polypropylenes available from Basell Polyolefins (Wilmington, Del.) under the trade designation BASELL™. In one desired embodiment of the present invention, the fibers of the meltblown fabric layer comprise polypropylene fibers formed from polypropylene available from Basell Polyolefins (Wilmington, Del.) under the trade designation BASELL™, and having a melt flow index of about 800 g/10 min as measured according to ASTM D-1238.

Desirably, the fibers of the meltblown fabric layer have an average fiber diameter of less than about 100 microns. More desirably, the fibers have an average fiber diameter of from about 0.5 micron to about 40 microns. Even more desirably, the fibers have an average fiber diameter of from about 10 micron to about 35 microns.

The meltblown fabric layer may have a basis weight, which varies depending upon the particular end use of the individual fabric layer and the resulting landscaping fabric. Desirably, the meltblown fabric layer has a basis weight of less than about 500 grams per square meter (gsm). More desirably, the meltblown fabric layer has a basis weight of from about 2.5 gsm to about 500 gsm. Even more desirably, the meltblown fabric layer has a basis weight of from about 8 gsm to about 160 gsm, even more desirably from about 25 gsm to about 140 gsm.

As with the basis weight, the meltblown web may have a thickness, which varies depending upon the particular end use of the individual fabric layer and the resulting landscaping fabric. Desirably, the meltblown web has a thickness of less than about 1000 microns (μm). More desirably, the meltblown web has a thickness of from about 10 μm to about 500 μm. Even more desirably, the meltblown web has a thickness of from about 20 μm to about 100 μm.

Commercially available meltblown fabrics suitable for use in the present invention include, but are not limited to, meltblown fabrics commercially available from BBA Simpsonville (Simpsonville, S.C.), Ergon Nonwovens, Inc. (Jackson, Miss.), Jentex Corporation (Buford, Ga.), American Nonwovens (Columbus, Miss.), or any other meltblown fabric manufacturer.

b. Needle-Punched Fabrics

In yet a further exemplary embodiment of the present invention, the landscaping fabric comprises one or more liquid-absorbing fabric layers, wherein at least one liquid-absorbing fabric layer comprises a layer of needle-punched fibers. The fibers of the needle-punched fabric layer may be any of the above-mentioned fibers or a combination thereof.

The needle-punched fabric layer may have a basis weight, which varies depending upon the particular end use of the individual fabric layer and the resulting landscaping fabric. Desirably, the needle-punched fabric layer has a basis weight of less than about 500 grams per square meter (gsm). More desirably, the needle-punched fabric layer has a basis weight of from about 10 gsm to about 200 gsm. Even more desirably, the needle-punched fabric layer has a basis weight of from about 20 gsm to about 150 gsm, even more desirably from about 70 gsm to about 100 gsm.

As with the basis weight, the needle-punched fabric layer may have a thickness, which varies depending upon the particular end use of the individual fabric layer and the resulting landscaping fabric. Desirably, the needle-punched fabric layer has a thickness of less than about 1000 microns (μm). More desirably, the needle-punched fabric layer has a thickness of from about 10 μm to about 500 μm. Even more desirably, the needle-punched fabric layer has a thickness of from about 20 μm to about 100 μm.

Any commercially available needle-punched fabric may be used in the present invention.

2. Other Fabric Layers

In addition to at least one liquid-absorbing fabric layer, the landscaping fabrics of the present invention may comprise one or more additional fabrics layers, which provide one or more properties to the resulting landscaping fabric. The one or more additional fabrics layers may possess some degree of liquid absorbency, but are present for reasons other than liquid absorbency such as reinforcement, support for the liquid-absorbing layer, tear resistance, etc. Suitable additional fabrics layers include, but are not limited to, nonwoven fabrics, woven fabrics, knitted fabrics, mesh fabrics, netting, unidirectional fiber sheets, or combinations thereof. In one desired embodiment of the present invention, the additional fabrics layer comprises a nonwoven fabric such as a spunbonded fabric, a woven fabric, or a unidirectional fiber sheet. Desirably, the fibers in each of the fabric layers comprise hydrophilic fibers and/or fibers at least partially coated with a hydrophilic material as described above.

3. Fabric Dimensions Like the basis weight and thickness described above for each fabric layer, each fabric layer may have a variety of fabric dimensions depending on the end use of the fabric. Typically, the overall width of each fabric layer is less than about 152 centimeters (cm) (60 in). In most applications, the overall width of each fabric layer ranges from about 30.5 cm (12 in) to about 142.2 cm (56 in). In other applications, the overall width of each fabric layer ranges from about 91.4 cm (36 in) to about 127.0 cm (50 in).

The overall length of each fabric layer may vary depending on the end use of the fabric, as well as, the desired roll size. Typically, the overall length of each fabric layer is less than about 100 meters (m) (328 ft). In most applications, the overall length of each fabric layer ranges from about 1.0 m (3.28 ft) to about 60 m (196.9 ft). In other applications, the overall length of each fabric layer ranges from about 5 m (16.4 ft) to about 40 m (131.2 ft).

B. Ingredients Incorporated Into the One or More Liquid-Absorbing Fabric Layers

One or more desired ingredients may be incorporated into the one or more fabrics layers of the landscaping fabrics of the present invention. Exemplary ingredients are described below.

1. Fertilizer

In one exemplary embodiment of the present invention, a fertilizer is incorporated into at least one liquid-absorbing fabric layer of the landscaping fabrics of the present invention. The fertilizer may be a water-soluble, solid fertilizer or a liquid fertilizer. Suitable fertilizers include, but are not limited to, nitrogen-containing inorganic fertilizers containing polymethylene urea, methylene diurea, monomethyol urea, urea formaldehyde, magnesium nitrate, nitric acid, and combinations thereof; phosphorus-containing inorganic fertilizers such as ammonium phosphate and diammonium phosphate; potassium-containing inorganic fertilizers such as potassium thiosulfate and potassium nitrate; and combinations thereof. Desirably, the fertilizer comprises a liquid fertilizer containing one or more compounds containing nitrogen, phosphorus and potassium.

The type of fertilizer may vary for a given landscaping fabric application. For example, a landscaping fabric for use with rose bushes or other flowering bushes may desirably contain a fertilizer comprising substantially equal amounts of nitrogen, phosphorus and potassium (i.e., a nitrogen content of 14%, a phosphorus content of 14%, and a potassium content of 14% based on a total weight of the fertilizer). In other applications such as for growing grass seed, a suitable landscaping fabric may desirably contain a fertilizer comprising a relatively high nitrogen content (i.e., a nitrogen content of 28% based on a total weight of the fertilizer).

A variety of commercially available fertilizers may be used in the present invention. Exemplary fertilizers suitable for use in the present invention include, but are not limited to, liquid fertilizers commercially available under the trade designation LiquiGreen® Fertilizers and LiquiGreen® Plus Fertilizers from Regal Chemical Company (Alpharetta, Ga.), such as the 30-0-0, 18-0-0, 18-0-0 (Mg) (i.e., contents 3 wt % Mg), 14-14-14, 15-0-12 (S) (i.e., contents 8 wt % S), 8-0-16, 7-0-0 (Mg) (i.e., contents 6.3 wt % Mg), and 10-34-0 LiquiGreen® Fertilizers; and fertilizers commercially available under the trade designations REGALITE®, MaxiGreen II®, MultiGreen II® from Regal Chemical Company (Alpharetta, Ga.). Other suitable fertilizers include, but are not limited to, Fairway Fertilizers, Greens Fertilizers, N & K Fertilizers, P, K & S Fertilizers, P & K Fertilizers, Starter Fertilizers, and other fertilizers commercially available from Regal Chemical Company (Alpharetta, Ga.) (www.regalchem.com).

The landscaping fabrics of the present invention desirably comprise up to about 305 grams (g) of fertilizer per square meter (m²) of landscaping fabric (i.e., about 1000 oz. of fertilizer/1000 ft² of landscaping fabric), although more fertilizer per unit area of fabric may be used. More desirably, the landscaping fabrics of the present invention comprise from about 61 to about 183 grams of fertilizer per square meter of landscaping fabric (i.e., from about 200 to about 600 oz. of fertilizer/1000 ft² of landscaping fabric). Even more desirably, the landscaping fabrics of the present invention comprise about 134 grams of fertilizer per square meter of landscaping fabric (i.e., about 440 oz. of fertilizer/1000 ft² of landscaping fabric).

Although sprayable liquid fertilizers are the desired fertilizers for use in the fabrics of the present invention, particulate fertilizers may also be used in some embodiments. In such embodiments, the particulate fertilizer is incorporated into at least one fabric layer during or after formation of the fabric layer.

2. Water Saving Crystals

In a further exemplary embodiment of the present invention, water saving crystals are incorporated into at least one liquid-absorbing fabric layer of the landscaping fabrics of the present invention. As used herein, the term “water saving crystals” is used to describe materials that trap and/or absorb water. The water saving crystals may be incorporated into a liquid-absorbing fabric layer of the landscaping fabrics as a separate component or as a mixture with one or more liquid fertilizers. Suitable water saving crystals include, but are not limited to, potassium hydrogel, cross-linked sodium polyacrylate, acrylic polyacrylaamide with a potassium salt base.

A variety of commercially available water saving crystals may be used in the present invention. Exemplary water saving crystals suitable for use in the present invention include, but are not limited to, water saving crystals commercially available under the trade designation TERRA-SORB® Potassium Hydrogel from Plant Health Care, Inc. (Pittsburg, Pa.), SOIL MOIST™ Hydrogel from Biocontrol Network (Brentwood, Tenn.), STOCKOSORB® Superabsorbent Polymers from Stockhausen (Greensboro, N.C.), and RESERVE H₂O water saving crystals commercially available from Regal Chemical Company (Alpharetta, Ga.).

When present, the landscaping fabrics of the present invention desirably comprise up to about 49 grams of water saving crystals per square meter of landscaping fabric (i.e., about 10 lbs. of water saving crystals/1000 ft² of landscaping fabric). More desirably, when present, the landscaping fabrics of the present invention comprise from about 9.8 to about 29.3 grams of water saving crystals per square meter of landscaping fabric (i.e., from about 2 to about 6 lbs. of water saving crystals/1000 ft² of landscaping fabric). Even more desirably, when present, the landscaping fabrics of the present invention comprise about 14.6 grams of water saving crystals per square meter of landscaping fabric (i.e., about 3 lbs. of water saving crystals/1000 ft² of landscaping fabric).

3. Fungicides

In yet a further exemplary embodiment of the present invention, a fungicide is incorporated into at least one liquid-absorbing fabric layer of the landscaping fabrics of the present invention. The fungicide may be incorporated into a liquid-absorbing fabric layer as a separate component or as a mixture with one or more liquid fertilizers, water saving crystals, or both. Suitable fungicides include, but are not limited to, fungicides containing mono- and di-potassiumn salts of phosphorus acid, chlorothalonil (i.e., tetrachloroisophthalonitrile), dimethyl 4,4-o-phenylenebis-3-thiophanate, flutolanil (i.e., N-[3-( 1-methylethoxy)phenyl]-2-(trifluoromethyl)benzamide), and combinations thereof. Desirably, the fungicide comprises mono- and di-potassium salts of phosphorus acid.

A variety of commercially available fungicides may be used in the present invention. Exemplary fungicides suitable for use in the present invention include, but are not limited to, fungicides commercially available under the trade designations Resyst®, ConSyst®, ChloroStar®, SysTec 1998® and SysStar® from Regal Chemical Company (Alpharetta, Ga.), such as ConSyst® WDG.

When present, the landscaping fabrics of the present invention desirably comprise up to about 3.0 grams of fungicide per square meter of landscaping fabric (i.e., about 10.0 oz. of fungicide/1000 ft² of landscaping fabric). More desirably, when present, the landscaping fabrics of the present invention comprise from about 0.30 to about 1.8 grams of fungicide per square meter of landscaping fabric (i.e., from about 1.0 to about 6.0 oz. of fungicide/1000 ft² of landscaping fabric). Even more desirably, when present, the landscaping fabrics of the present invention comprise about 0.6 grams of fungicide per square meter of landscaping fabric (i.e., about 2.0 oz. of fungicide/1000 ft² of landscaping fabric).

4. Pre-Emergent Weed Killers

In yet a further exemplary embodiment of the present invention, a pre-emergent weed killer is incorporated into at least one liquid-absorbing fabric layer of the landscaping fabrics of the present invention. The pre-emergent weed killer may be incorporated into a liquid-absorbing fabric layer as a separate component or as a mixture with one or more liquid fertilizers, water saving crystals, fungicides, or a combination thereof. Suitable pre-emergent weed killers include, but are not limited to, prodiamine (i.e., N3,N3-Di-n-propyl-2,4-dinitro-6-(triflouromethyl)-m-phenylenediamine); oxadiazon (i.e., 2-tert-butyl-4-(2,4-dichloro-5-isopropoxyphenyl)-delta-1,3,4-oxadiazolin-5-one; oxyfluorfen (i.e., 2-chloro-1-(3-ethoxy-4-nitrophenoxy)-4-(trifluoro-methyl)benzene); and combinations thereof. Desirably, the pre-emergent weed killer comprises prodiamine.

A variety of commercially available pre-emergent weed killers may be used in the present invention. Exemplary pre-emergent weed killers suitable for use in the present invention include, but are not limited to, pre-emergent weed killers commercially available under the trade designation RegalKade® Herbicide from Regal Chemical Company (Alpharetta, Ga.), such as RegalKade® G; and pre-emergent weed killers commercially available under the trade designation RegalStar® from Regal Chemical Company (Alpharetta, Ga.), such as RegalStar® G and RegalStar® II. Other suitable pre-emergent weed killers include, but are not limited to 0-0 Herbicides® and RonStar® products commercially available from Regal Chemical Company (Alpharetta, Ga.) such as RonStar® AC, RonStar® Plus, and RonStar® Plus 1%.

When present, the landscaping fabrics of the present invention desirably comprise up to about 0.5 grams of pre-emergent weed killer per square meter of landscaping fabric (i.e., about 1.6 oz. of pre-emergent weed killer/1000 ft² of landscaping fabric). More desirably, when present, the landscaping fabrics of the present invention comprise from about 0.075 to about 0.23 grams of pre-emergent weed killer per square meter of landscaping fabric (i.e., from about 0.25 to about 0.75 oz. of pre-emergent weed killer/1000 ft² of landscaping fabric). Even more desirably, when present, the landscaping fabrics of the present invention comprise about 0.15 grams of pre-emergent weed killer per square meter of landscaping fabric (i.e., about 0.50 oz. of pre-emergent weed killer/1000 ft² of landscaping fabric).

5. Post-Emergent Weed Killers

In yet a further exemplary embodiment of the present invention, a post-emergent weed killer is incorporated into at least one liquid-absorbing fabric layer of the landscaping fabrics of the present invention. The post-emergent weed killer may be incorporated into a liquid-absorbing fabric layer as a separate component or as a mixture with one or more fertilizers, water saving crystals, fungicides, pre-emergent weed killers, or a combination thereof. Suitable post-emergent weed killers contain one or more active ingredients including, but are not limited to, a dimethylamine salt of 2,4-dichlorophenoxyacetic acid (“2,4-D”); a dimethylamine salt of 2-(2-methyl-4-chlorophenoxy)propionic acid (“MCPP”); a dimethylamine salt of 3,6-dichloro-o-anisic acid (“dicamba”); clopyralid; and mixtures thereof.

A variety of commercially available post-emergent weed killers may be used in the present invention. Exemplary post-emergent weed killers suitable for use in the present invention include, but are not limited to, post-emergent weed killers commercially available under the trade designation TRIMEC from Regal Chemical Company (Alpharetta, Ga.), such as TRIMEC 992, TRIMEC Bentgrass, TRIMEC Classic, TRIMEC Plus, TRIMEC Southern, and Super TRIMEC; and post-emergent weed killers commercially available under the trade designations TRIPLET and TRIAMINE from Regal Chemical Company (Alpharetta, Ga.), such as TRIPLET SF.

When present, the landscaping fabrics of the present invention desirably comprise up to about 0.92 grams of post-emergent weed killer per square meter of landscaping fabric (i.e., about 3.0 oz. of post-emergent weed killer/1000 ft² of landscaping fabric). More desirably, when present, the landscaping fabrics of the present invention comprise from about 0.15 to about 0.46 grams of post-emergent weed killer per square meter of landscaping fabric (i.e., from about 0.50 to about 1.50 oz. of post-emergent weed killer/1000 ft² of landscaping fabric). Even more desirably, the landscaping fabrics of the present invention comprise about 0.30 grams of post-emergent weed killer, when present, per square meter of landscaping fabric (i.e., about 1.0 oz. of post-emergent weed killer/1000 ft² of landscaping fabric).

6. Additives

In addition to the ingredients mentioned above, various additives may be added to one or more of the ingredients and incorporated into the one or more fabric layers of the landscaping fabrics of the present invention. Suitable additives include, but are not limited to, fillers, stabilizers, plasticizers, tackifiers, flow control agents, adhesion promoters, adjuvants, silica, clay, talc, pigments, colorants, scent-producing agents, surfactants, antioxidants, optical brighteners; antimicrobial agents, and fire retardants. Typically, the amount of one or more additives is less than about 25 weight percent, desirably, up to about 2.5 percent, based on the total weight of the fertilizer-containing composition.

In one exemplary embodiment of the present invention, a surfactant may be added to a fertilizer-containing composition in an amount of up to about 1.0 weight percent, based on the total weight of the fertilizer-containing composition.

C. One or More Protective Coating Layers

The landscaping fabrics of the present invention may further comprise one or more protective coating layers on one or more outer surfaces of the fabric layers described above. Protective coating layers may be used to protect a user from direct exposure to any of the above-mentioned ingredients within the landscaping fabric. Suitable protective coating layers include, but are not limited to, water-soluble or water-degradable coatings and films, and temporarily applied release liners.

1. Water-Soluble or Water-Degradable Protective Coating Layers

In one embodiment of the present invention, the protective layer comprises a water-soluble or water-degradable coating or film. Suitable water-soluble or water-degradable materials for use in the present invention include, but are not limited to, polyvinyl alcohol; polyacrylic acid; polymethacrylic acid; polyacrylamide; water-soluble cellulose derivatives such as methyl celluloses, ethyl celluloses, hydroxymethyl celluloses, hydroxypropyl methyl celluloses, and carboxymethyl celluloses; carboxymethylchitin; polyvinyl pyrrolidone; ester gum; water-soluble derivatives of starch such as hydroxypropyl starch and carboxymethyl starch; and water-soluble polyethylene oxides. Suitable alkali water-soluble materials for use in the present invention include, but are not limited to, ethylene copolymers of acrylic acid (EAA) and methacrylic acid (EMAA), and salts thereof; and ionomers containing acrylic acid and/or methacrylic acid. Desirably, the water-soluble material comprises polyvinyl alcohol with or without acetyl groups, cross-linked or uncross-linked.

The protective coating or film layer may contain any of the above-described water-soluble materials alone or in combination with water-insoluble materials. Desirably, the construction of the protective coating or film layer is such that the protective coating or film layer either (1) completely dissolves or (2) breaks up into small particles or pieces when exposed to water.

In some embodiments of the present invention, the protective coating or film layer comprises water-soluble material alone or in combination with water-insoluble material. When water-insoluble materials are used to form a protective coating or film layer, desirably less than about 50 parts by weight (pbw) of water-insoluble material is used in combination with at least about 50 parts by weight (pbw) of water-soluble material to form the protective coating or film layer, based on a total parts by weight of the protective coating or film layer. More desirably, the protective coating or film layer comprises at least about 70 pbw of water-soluble material and less than about 30 pbw of water-insoluble material, even more desirably, at least about 90 pbw of water-soluble material and less than about 10 pbw of water-insoluble material, based on a total parts by weight of the protective coating or film layer.

In a further embodiment, the protective coating or film layer consists essentially of water-soluble material. As used herein, the term “consists essentially of water-soluble material” refers to a protective coating or film layer that contains one of more water-soluble materials, and possibly a fillers material, colorant, or other inert material. In yet a further embodiment, the protective coating or film layer consists of water-soluble material. As used herein, the term “consists of water-soluble material” refers to a protective coating or film layer that contains only one of more water-soluble materials without additional components.

The protective coating or film layer may have an average coating or film thickness that varies depending upon a number of factors including, but not limited to, the water solubility of the coating material, and the ingredients used to impregnate the liquid-absorbing fabric layer. Typically, the protective coating or film layer has an average coating or film thickness of less than about 1000 microns (μm), desirably, from about 10 to about 500 μm, and more desirably, from about 25 to about 75 μm.

A variety of commercially available water-soluble films may be used in the present invention. Exemplary water-soluble films suitable for use in the present invention include, but are not limited to, water-soluble films commercially available under the trade designation MONOSOL® from MonoSol, LLC (Portage, Ind.), such as MONOSOL® products M-8534, M-8630, M-9500, M-7061, M-7031 and M-7030.

A tie layer or adhesive layer may be used to enhance adhesion between the outer surface of a given fabric layer and the protective coating or film layer. In some cases, the protective coating or film layer adheres to an outer surface of a given fabric layer without the need for a separate tie or adhesive layer. When present, the tie or adhesive layer comprises a continuous or discontinuous layer of adhesive material such as a mucilage-type material.

2. Removable Release Liners

In a further embodiment of the present invention, the protective layer comprises a removable release liner. The removable release liner exhibits adhesion to an outer surface of a fabric layer (or a tie or adhesive layer thereon), but may be easily removed due to the release properties of the release liner. Suitable release liners for use in the present invention include, but are not limited to, a polymeric film (e.g., polyethylene film), a paper substrate, a polymeric film coated with a release material (e.g., polyethylene film coated with a silicone release agent), and a paper substrate coated with a release material.

As described above, suitable release liners may be used to provide protection to a user from direct exposure to ingredients within the landscaping fabrics of the present invention. In addition, some release liners may also provide support for and/or reinforcement of the liquid-absorbing layer of the landscaping fabric.

C. One or More Reinforcing Layers

The landscaping fabrics of the present invention may further comprise one or more reinforcing layers on one or more outer surfaces of the fabric layers described above. Suitable reinforcing layers or substrates include, but are not limited to, any of the above-described fabric layers, any of the above-mentioned release liners, films, foams, or a combination thereof. In one desired embodiment of the present invention, the landscaping fabric comprises a reinforcing layer in the form of a spunbonded fabric layer. In a further desired embodiment of the present invention, the landscaping fabric comprises a reinforcing layer in the form of an apertured polymeric film permanently attached (i.e., bonded) to the one of more fabric layers. In yet a further desired embodiment of the present invention, the landscaping fabric comprises a reinforcing layer in the form of a unidirectional fiber sheet having fibers aligned in a machine direction of the landscaping fabric.

II. Methods of Making Landscaping Fabrics

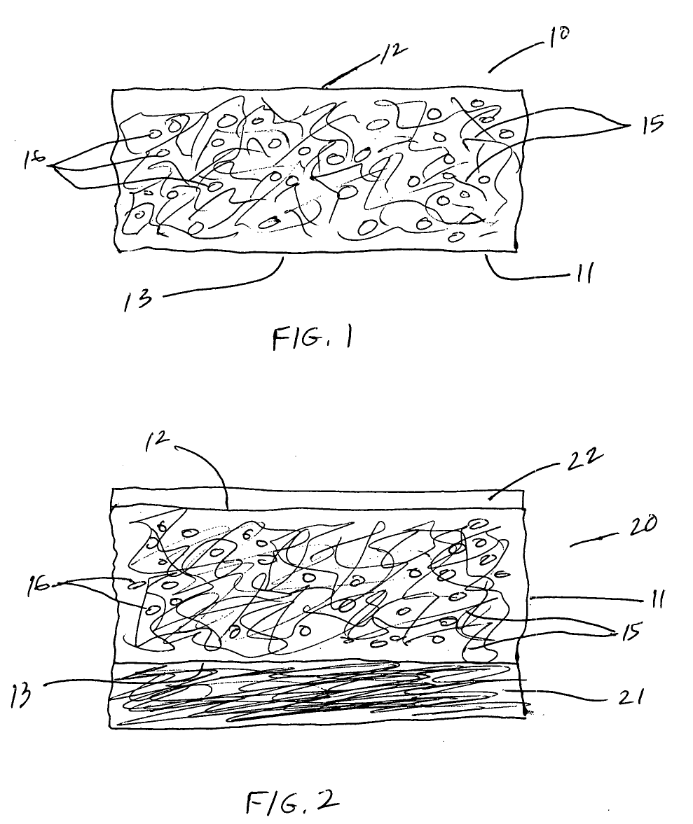

The components described above may be used to prepare a landscaping fabric of the present invention. An exemplary landscaping fabric and its components are shown in FIG. 1. As shown in FIG. 1, exemplary landscaping fabric 10 comprises a liquid-absorbing fabric 11 including extruded polypropylene fibers 15 and one or more ingredients 16 distributed throughout polypropylene fibers 15. Liquid-absorbing fabric 11 has an upper surface 12 and a lower surface 13 that can be bonded to one or more additional layers as described above. Liquid-absorbing fabric 11 may comprise any of the above-mentioned fabrics, such as a meltblown or spunbonded fabric layer.

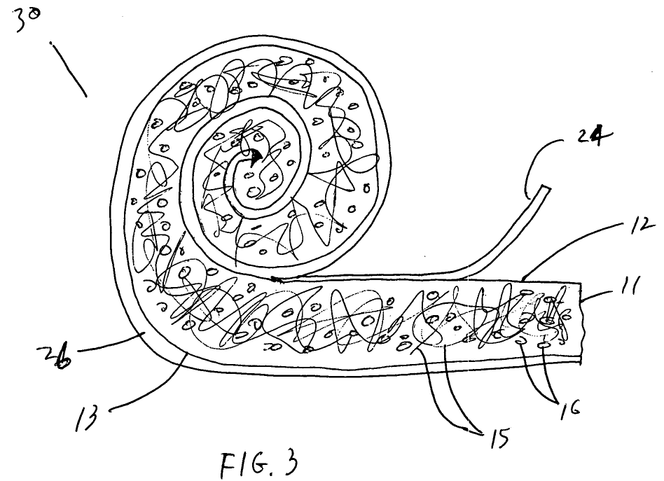

Another exemplary landscaping fabric of the present invention is shown in FIG. 2. The exemplary landscaping fabric 20 of FIG. 2 comprises upper liquid-absorbing fabric layer 11 bonded to lower reinforcing fabric layer 21. For example, upper liquid-absorbing fabric layer 11 may be an absorbent meltblown nonwoven fabric of polypropylene fibers, and lower reinforcing fabric layer 21 may be a spunbonded nonwoven fabric of polypropylene fibers. Although upper liquid-absorbing fabric layer 11 may be bonded to reinforcing fabric layer 21 using a variety of bonding processes as described below, exemplary landscaping fabric 20 of FIG. 2 desirably comprises a uniform bond along lower surface 13 of upper liquid-absorbing fabric layer 11.

As shown in FIG. 2, exemplary landscaping fabric 20 further comprises a protective coating or film 22 adhered to upper surface 12 of upper liquid-absorbing fabric layer 11. Protective coating or film 22 may comprise a water-soluble coating or film or may comprise a removable release liner as described above. It should be noted that other reinforcing layers may be used in place of or in addition to lower reinforcing fabric layer 21 shown in FIG. 2. Further, it should be noted that additional liquid-absorbing fabric layers may be used in addition to upper liquid-absorbing fabric layer 11 shown in FIG. 2.

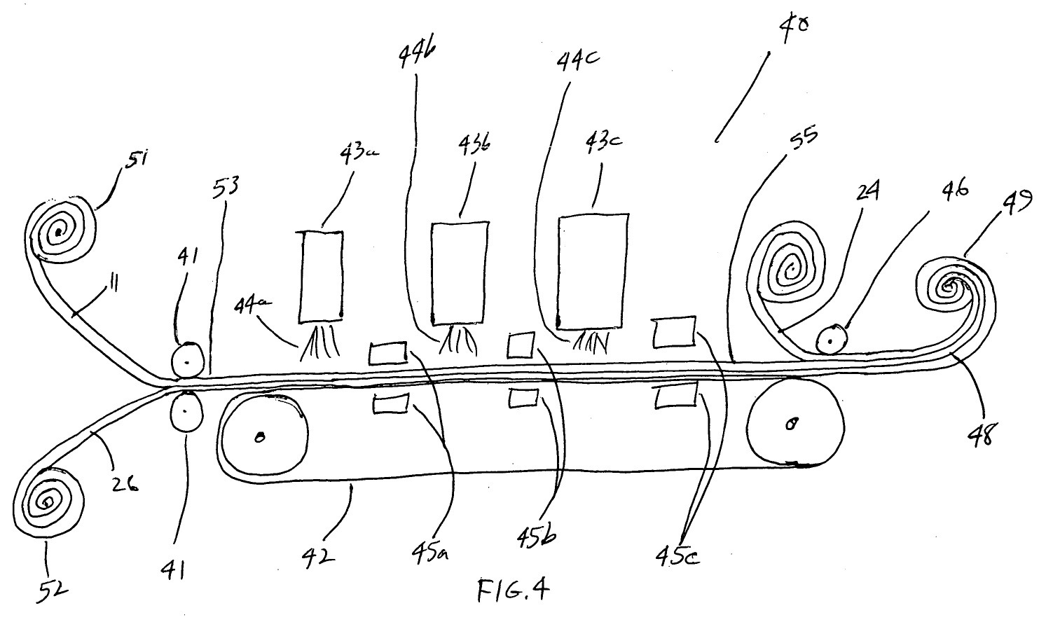

FIG. 3 depicts a roll of landscaping fabric 30 comprising upper liquid-absorbing fabric layer II, removable release film 24 adhered to upper surface 12 of upper liquid-absorbing fabric layer 11, and reinforcing layer 26 adhered to lower surface 13 of upper liquid-absorbing fabric layer 11. In one embodiment of the present invention, removable release film 24 may extend along the full length of liquid-absorbing fabric layer 11. In other embodiments of the present invention (such as shown in FIG. 3), removable release film 24 may extend along a portion of the length of liquid-absorbing fabric layer 11 to provide protection during an unrolling process step of applying the landscaping fabric to a given surface.

The landscaping fabrics of the present invention may be prepared in a number of ways. One exemplary method of making a landscaping fabric is depicted in FIG. 4. As shown in FIG. 4, liquid-absorbing fabric layer 11 is pulled from fabric roll 51 and joined to reinforcing layer 26 at nip rolls 41. Heat and/or pressure may be used at nip rolls 41 to join liquid-absorbing fabric layer 11 to reinforcing layer 26 (pulled from roll 52) to form composite 53. In addition, if necessary, an adhesive may be used to enhance the bond between liquid-absorbing fabric layer 11 to reinforcing layer 26. Composite 53 proceeds along belt 42 under one or more ingredient applicators and between one or more dryers/heaters.

As shown in FIG. 4, composite 53 proceeds under applicators 43a, 43b and 43c and between dryer elements 45a, 45b and 45c. Applicators 43a, 43b and 43c may be used to apply one or more materials 44a, 44b and 44c (i.e., fertilizers, fungicides, water saving crystals, herbicides, pre-emergent or post-emergent weed killers, additives, or a combination thereof). When a water-soluble protective coating is applied to an outer surface of liquid-absorbing fabric layer 11, one or more of the applicators may be used to apply water-soluble protective coating onto liquid-absorbing fabric layer 11 (such as applicator 43c or applicators 43b and 43c). When necessary, one or more dryer elements may be used to dry the applied ingredient prior to (i) applying the next ingredient or (ii) rolling up the final landscaping fabric. As shown in FIG. 4, dryer elements 45a, 45b and 45c may be used to dry composite 53 after each application from applicators 43a, 43b and 43c, forming dried composite 55. Room temperature air or heated air may be used to dry the landscaping fabrics depending on the desired drying time. When heated air is used, the air temperature may be 100° C. (212° F.) or higher, but is typically about 50° C. (122° F.) to about 100° C. (212° F.).

Dried composite 55 may proceed further along belt 42 so that removable release liner 24 (or water-soluble film 24) may be applied to dried composite 55 at nip roller 46 to form finished landscaping fabric 48. Heat and/or pressure may be used at nip roller 46 to join release liner 24 (or water-soluble film 24) to dried composite 55. In addition, if necessary, an adhesive may be used to enhance the bond between release liner 24 (or water-soluble film 24) and dried composite 55 (such as an adhesive applied via an applicator, such as applicator 43c as shown in FIG. 4). Finished landscaping fabric 48 may then be taken up as roll 49.

The method of forming landscaping fabrics of the present invention may include any of the above-described process steps. In addition, the method of forming landscaping fabrics may include one or more of the following process steps:
(1) forming a liquid-absorbing fabric layer;
(2) forming a reinforcing layer;
(3) forming a mixture of ingredients to apply to the liquid-absorbing fabric layer;
(4) applying a continuous or discontinuous adhesive layer onto the liquid-absorbing fabric layer, a reinforcing layer when present, a release liner when present, or all of the above;
(5) forming a liquid-absorbing fabric layer directly onto a reinforcing layer or other support layer;
(6) applying one or more particulates to the liquid-absorbing fabric layer;
(7) incorporating one or more particulates into the liquid-absorbing fabric layer during formation of the liquid-absorbing fabric layer;
(8) combining two or more liquid-absorbing fabric layers with one or more reinforcing layers, protective coatings or films, and/or one or more release liners;
(9) attaching the finished landscaping fabric to a cardboard or plastic tube; and
(10) slitting the finished landscaping fabric to form two or more slit rolls.
   III. Uses for the Landscaping Fabrics

The landscaping fabrics of the present invention may be used in a variety of applications including residential (e.g., gardening, novice landscaping), commercial (e.g., plant and grass growing businesses, professional landscaping), industrial (e.g., erosion prevention), and government applications (e.g., highway projects). The landscaping fabrics of the present invention may be used as (i) a ground cover for a plant growing medium, (ii) a roll-up liner for sod farms, (iii) a flower flat, (iv) a house mat for growing plants indoors, (v) a wildflower growing medium for plant erosion control, (vi) a growing medium for potted plants, (vii) a greenhouse barrier, and (viii) a customized plant growing and/or farming business.

The present invention is described above and further illustrated below by way of examples, which are not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLE 1

### Preparation of a Landscaping Fabric

A sprayable fertilizer-containing composition was prepared using the ingredients as shown in Table 1 below.

TABLE 1
Sprayable Fertilizer-Containing Composition

| | | Amount |
|---|---|---|
| Component | Purpose | (g) |
| LiquiGreen ® 14—14—14 | fertilizer | 1340 |
| RESERVE H₂O ® | water saving crystals | 146 |
| water | solvent/carrier | 195 |

The sprayable fertilizer-containing composition was sprayed onto an outer surface of a hydrophilic polypropylene spunbonded fabric having a basis weight prior to the spraying step of about 68 grams per square meter (gsm). The landscaping fabric was then dried at a drying temperature of about 65° C. (150° F.) to remove water.

The finished landscaping fabric had a basis weight of 216.6 gsm. The total content of dried ingredients within the landscaping fabric was 148.6 gsm.

### EXAMPLE 2

### Preparation of a Landscaping Fabric

A sprayable fertilizer-containing composition was prepared using the ingredients as shown in Table 2 below.

TABLE 2
Sprayable Fertilizer-Containing Composition

| | | Amount |
|---|---|---|
| Component | Purpose | (g) |
| LiquiGreen ® 14—14—14 | fertilizer | 1340 |
| Resyst ® fungicide | fungicide | 60 |
| RegalKade ® G | herbicide | 1.5 |
| RESERVE H₂O ® | water saving crystals | 146 |
| water | solvent/carrier | 195 |

The sprayable fertilizer-containing composition was sprayed onto an outer surface of a hydrophilic polypropylene spunbonded fabric as described in Example 1. The landscaping fabric was then dried at a drying temperature of about 65° C. (150° F.) to remove water.

The finished landscaping fabric had a basis weight of 222.75 gsm. The total content of dried ingredients within the landscaping fabric was 154.75 gsm.

### EXAMPLE 3

### Preparation of a Landscaping Fabric Having an Outer Protective Layer Comprising a Water-Soluble Film

A landscaping fabric was prepared as in Example 2. Prior to the drying step, a water-soluble polyvinyl alcohol film commercially available from MonoSol, LLC (Portage, Ind.) under the trade designation, MONOSOL® M-8534, and having a film thickness of about 50 microns (μm) was applied, with pressure, over the sprayable composition. The landscaping fabric was then dried at a drying temperature of about 65° C. (150° F.) to remove water.

### EXAMPLE 4

### Preparation of a Landscaping Fabric Having an Outer Protective Layer Comprising a Removable Release Liner

A landscaping fabric was prepared as in Example 2 except, prior to the drying step, a removable release liner comprising a silicone coated paper sheet was brought into contact with the sprayable coating. The landscaping fabric was then dried at a drying temperature of about 65° C. (150° F.) to remove water.

### EXAMPLE 5

### Preparation of a Landscaping Fabric Having an Outer Protective Layer Comprising a Water-Soluble Coating

A landscaping fabric was prepared as in Example 2. A water-soluble coating comprising polyvinyl alcohol was then applied over the sprayable coating on a dried upper surface of the landscaping fabric to provide a water-soluble coating thickness of about 25 microns (μm).

### EXAMPLE 6

### Preparation of a Landscaping Fabric Having Multiple Fabric Layers and an Outer Protective Layer Comprising a Water-Soluble Coating

A landscaping fabric was prepared by forming a composite fabric comprising a meltblown fabric on an outer surface of the spunbonded fabric used in Example 1. The meltblown fabric was formed from polypropylene fibers having a basis weight of about 36 gsm. A sprayable composition as shown in Table 2 above was sprayed onto an upper surface of the meltblown fabric. The composite landscaping fabric prior to the spraying step had a basis weight of about 104 grams per square meter (gsm). The dried landscaping fabric had a basis weight of 258.75 gsm. The total content of dried ingredients within the landscaping fabric was 154.75 gsm.

After drying, a water-soluble coating comprising polyvinyl alcohol was applied over the sprayable coating, onto the upper surface of the meltblown fabric to provide a water-soluble coating thickness of about 25 microns (μm).

### EXAMPLE 7

### Preparation of a Landscaping Fabric Having Multiple Fabric Layers and an Outer Protective Layer Comprising a Water-Soluble Coating

A landscaping fabric was prepared as in Example 6 except a sheet of unidirectional polypropylene fibers was used in place of the spunbonded fabric layer. The composite landscaping fabric prior to the spraying step had a basis weight of about 106 grams per square meter (gsm). The dried landscaping fabric had a basis weight of 260.75 gsm. The total content of dried ingredients within the landscaping fabric was 154.75 gsm.

After drying, a water-soluble coating comprising polyvinyl alcohol was applied over the sprayable coating, onto the upper surface of the meltblown fabric to provide a water-soluble coating thickness of about 25 microns (μm).

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

1. A landscaping fabric comprising:
at least one fabric comprising a plurality of fibers and interstitial voids throughout the plurality of fibers, wherein the at least one fabric has an upper surface and a lower surface;
a nitrogen-containing fertilizer within the at least one fabric, said fertilizer coating at least a portion of the plurality of fibers and occupying at least a portion of the interstitial voids within the at least one fabric; and
an outermost protective layer at least partially covering (i) the upper surface of the at least one fabric, (ii) the lower surface of the at least one fabric, or (iii) both the upper and lower surfaces of the at least one fabric, wherein the outermost protective layer comprises a water-soluble coating, a water-soluble film, or a removable release liner.

2. The landscaping fabric of claim 1, wherein the at least one fabric further comprises water saving crystals within the at least one fabric, said water saving crystals coating at least a portion of the plurality of fibers and occupying at least a portion of the interstitial voids within the at least one fabric.

3. The landscaping fabric of claim 1, wherein the at least one fabric further comprises a fungicide within the at least one fabric, said fungicide coating at least a portion of the plurality of fibers and occupying at least a portion of the interstitial voids within the at least one fabric.

4. The landscaping fabric of claim 1, wherein the at least one fabric further comprises a pre-emergent weed killer within the at least one fabric, said pre-emergent weed killer coating at least a portion of the plurality of fibers and occupying at least a portion of the interstitial voids within the at least one fabric.

5. The landscaping fabric of claim 1, wherein the at least one fabric further comprises a mixture of water saving crystals, a fungicide and a pre-emergent weed killer within the at least one fabric, said mixture occupying at least a portion of the interstitial voids within the at least one fabric.

6. The landscaping fabric of claim 1, wherein the outermost protective layer comprises a water-soluble film.

7. The landscaping fabric of claim 1, wherein the outermost protective layer comprises a water-soluble coating.

8. The landscaping fabric of claim 7, wherein the water-soluble coating comprises a polyvinyl acetate, a polyvinyl alcohol, or a combination thereof.

9. The landscaping fabric of claim 1, wherein the outermost protective layer comprises a removable release liner, said removable release liner comprising a polymeric film, a paper substrate, a polymeric film coated with a release material, or a paper substrate coated with a release material.

10. The landscaping fabric of claim 1, wherein the at least one fabric comprises a meltblown fabric.

11. The landscaping fabric of claim 10, wherein the meltblown fabric comprises polypropylene fibers.

12. The landscaping fabric of claim 11, wherein the meltblown fabric has a basis weight of from about 28 grams per square meter (gsm) to about 70 gsm, and comprises hydrophilic polypropylene fibers having an average fiber diameter of from about 10 microns (μm) to about 40 μm.

13. The landscaping fabric of claim 1, further comprising:
a reinforcing substrate integrally bonded to (i) the upper surface of the at least one fabric, (ii) the lower surface of the at least one fabric, or (iii) both the upper and lower surfaces of the at least one fabric.

14. The landscaping fabric of claim 1, wherein the outermost protective layer at least partially covers an outer surface of the at least one fabric, and the landscaping fabric further comprises:
a reinforcing substrate integrally bonded to an outer surface of the at least one fabric opposite the outermost protective layer.

15. The landscaping fabric of claim 13, wherein the reinforcing substrate comprises a spunbonded fabric.

16. The landscaping fabric of claim 15, wherein the spunbonded fabric comprises hydrophilic polypropylene fibers.

17. The landscaping fabric of claim 13, wherein the reinforcing substrate comprises a polymeric film.

18. A roll of landscaping fabric, wherein the landscaping fabric comprises the landscaping fabric of claim 1.

19. A landscaping system comprising:
a plant growing medium comprising soil, sand, dirt, compost, or a combination thereof, and
the landscaping fabric of claim 1 positioned over the plant growing medium.

20. The landscaping system of claim 19, further comprising:
one or more plants growing in the plant growing medium and extending through opening within the landscaping fabric of claim 1.

21. A method of making the landscaping fabric of claim 1, said method comprising:
spraying at least one fabric-with a sprayable composition containing a nitrogen-containing fertilizer; and
applying a protective layer onto an outer surface of the at least one fabric.

22. A landscaping fabric comprising:
at least one fabric comprising a plurality of fibers and interstitial voids throughout the plurality of fibers, wherein the at least one fabric has an upper surface and a lower surface; and
a nitrogen-containing fertilizer within the at least one fabric, said fertilizer coating at least a portion of the plurality of fibers and occupying at least a portion of the interstitial voids within the at least one fabric;
wherein the landscaping fabric is substantially free of seeds.

23. The landscaping fabric of claim 22, wherein the at least one fabric further comprises a mixture of water saving crystals, a fungicide and a pre-emergent weed killer within the at least one fabric, said mixture occupying at least a portion of the interstitial voids within the at least one fabric.

24. The landscaping fabric of claim 22, further comprising an outermost protective layer comprises a water-soluble coating or film.

25. The landscaping fabric of claim 24, wherein the water-soluble coating or film comprises a polyvinyl acetate, a polyvinyl alcohol, or a combination thereof.

26. The landscaping fabric of claim 22, wherein the outermost protective layer comprises a removable release liner, said removable release liner comprising a polymeric film, a paper substrate, a polymeric film coated with a release material, or a paper substrate coated with a release material.

27. The landscaping fabric of claim 22, wherein the at least one fabric comprises a meltblown fabric.

28. The landscaping fabric of claim 27, wherein the meltblown fabric comprises hydrophilic polypropylene fibers.

29. The landscaping fabric of claim 27, wherein the meltblown fabric has a basis weight of from about 28 grams per square meter (gsm) to about 70 gsm, and comprises hydrophilic polypropylene fibers having an average fiber diameter of from about 10 microns (μm) to about 40 μm.

30. The landscaping fabric of claim 22, wherein the outermost protective layer at least partially covers an outer surface of the at least one fabric, and the landscaping fabric further comprises:
a reinforcing substrate integrally bonded to an outer surface of the at least one fabric opposite the outermost protective layer.
